(19) United States
(12) Patent Application Publication
(10) Pub. No.: US 2010/0014027 A1
(43) Pub. Date: Jan. 21, 2010

(54) LED BACKLIGHT HAVING EDGE ILLUMINATOR FOR FLAT PANEL LCD DISPLAYS

(75) Inventors: Lin Li, St. Petersburg, FL (US); Israel J. Morejon, Tampa, FL (US)

Correspondence Address: Jabil Circuit, Inc.;c/o Darby & Darby P.C., P.O. BOx 770, Church Street Station, New York, NY, 10008-0770, US

(73) Assignee: Jabil Circuit, Inc., St. Petersburg, FL (US)

(21) Appl. No.: 12/504,128

(22) Filed: Jul. 16, 2009

Related U.S. Application Data
(60) Provisional application No. 61/081,287, filed on Jul. 16, 2008.

(51) Int. Cl. G02F 1/13357

(52) U.S. Cl. 349/65; 362/97.3

(57) ABSTRACT

One or more embodiments of the present invention provide apparatuses and systems to form edge-illuminated LED backlight units for flat-panel LCD displays. The backlight unit is able to achieve uniform color and brightness distribution with very small dimensions of depth and bezels. One or more embodiments of the present invention include a light guide coupled to a light guide plate, which, by operating together, provide simple, efficient, few LEDs and low cost backlight units. Effective coupling structures provide high system efficiency.

### CROSS REFERENCE TO RELATED APPLICATIONS

This non-provisional U.S. Patent Application claims the benefit of U.S. Provisional Patent Application No. 61/081,287 entitled “LED BACKLIGHT HAVING EDGE ILLUMINATOR FOR FLAT PANEL LCD DISPLAYS” filed on Jul. 16, 2008, the disclosure of which is incorporated herein by reference.

### BACKGROUND OF THE INVENTION

1. Statement of the Technical Field

This invention pertains to innovative LED-based backlight units used for flat panel LCD displays, in particular pertaining to light guide architectures having low cost, high efficiency, few LEDs, and uniform light distribution across a display screen.

2. Description of the Related Art

Light emitting diodes (LEDs) are gradually extending their applications in LCD backlight units from small panels to large screen LCD displays. One typical approach, known as direct backlighting, disposes an array of LEDs directly on the back surface of a backlight unit. A drawback of direct backlighting is that hot spots from individual LEDs may be visible on the screen unless either the LED array is dense, or the backlight unit is deep. Preferably the backlight unit is compact, therefore the LED array should be dense in order to eliminate hot spots for uniformly illuminating LCD displays such as flat panel HDTVs. Some large screen LCD TVs use hundreds or thousands of LEDs to form a matrix of point light sources on the backplane of a backlight unit for LCD panel illumination. The use of such a huge number of LEDs results in complex control systems and significantly increases the cost of LED backlight units, making it difficult for LED-based backlight units to compete with conventional low-cost CCFL backlighting systems.

### SUMMARY OF THE INVENTION

Compared to direct backlighting, an edge-lit arrangement has advantages such as reducing the depth and making the backlight unit thinner by placing LEDs along the sides and using very thin light guides to uniformly distribute light across the LCD panel. While it is easy to implement LEDs which emit white light in a backlighting system, red, green and blue (RGB) LEDs can provide a much wider color gamut and result in superior color displays. In an edge-lit based backlight unit, light rays from small RGB LED light sources are first coupled into light guides and then the light guides carry light internally. The light guide may also be referred to as a guide or a light guide plate. The guide has input surfaces from which light is coupled into the light guide.

Simple and thin light guide architectures with fewer LEDs can greatly reduce the cost of LED backlight units and promotes adoption of this technique into the mainstream in flat panel LCD displays. Light from the LED light sources can be coupled into a rectangular light guide from both lateral sides of the guide. A transition region known as the color mixing distance is provided between the LEDs and the illumination region of the guide. When the transverse dimension of the rectangular light guide is small, the associated color mixing distance is very short and color light from the individual RGB LEDs can be mixed very well before the light is extracted out from the guide. It is desirable that the color mixing distance be kept short so that the size of the bezel surrounding the flat panel LCD display can be kept small.

The backlight illumination is provided by a light guide plate. The light guide plates used in the backlighting units are made from a substantially transparent bulk plastic material. An example of a bulk material used in injection-molded light guides is acrylic (PMMA) for low cost, lightweight, and less light absorption. The light guide plate will further include micro-structures (i.e., micro-lenses) on the top and bottom surfaces to extract light out from the light guide for illuminating the viewing area of the LCD display. Because the micro-lenses can be made very small and dense, uniform light distribution can be achieved on large LCD screens even the backlight units are very slim.

One or more embodiments of the present invention are able to achieve good brightness and good color uniformity by use of light-reshaping structures that produce a well-mixed and color-balanced distribution of light. The light-reshaping structures allow the design to use fewer LEDs, and fewer electrical components, thereby producing a design that is low-cost, thin and simple.

One or more embodiments of the present invention provides an edge-illuminated LED backlight apparatus that produces uniform light distribution for LCD displays, including an elongated light-transmissive bulk material having a first end, a second end, a central axis running from the first end to the second end, a first edge surface connecting the first end and the second end, and a second edge surface opposing said first edge surface; further including first and second input windows on the first and second ends, respectively, the first and second input windows configured to allow light from a plurality of light sources to enter the bulk material; further including a plurality of light extractors disposed on the first edge surface of the bulk material, each of said light extractors configured to allow a portion of light to escape from the interior of the bulk material; further including a flat light-transmissive bulk material having a first major surface, a second major surface, and an edge surface transverse to the first major surface and the second major surface, wherein the edge surface of the flat light-transmissive bulk material is optically coupled to the light extractors of the elongated light-transmissive bulk material; and further including a plurality of micro-lenses disposed on at least one major surface of the flat light-transmissive bulk material.

One or more embodiments of the present invention provides a method for coupling and re-distributing light in a LCD backlight unit, the method including a step of communicating light from a plurality of light sources, through an input window, into an elongated light-transmissive bulk material; further including a step of emitting said light from the elongated bulk material, through a plurality of light extractors disposed on a first edge of the elongated bulk material, into a flat light-transmissive bulk material; and further including a step of emitting said light from the flat light-transmissive bulk material through a plurality of micro-lenses disposed on at least one major surface of the flat light-transmissive bulk material.

### BRIEF DESCRIPTION OF THE DRAWINGS

Features illustrated in the figures are not drawn to scale unless explicitly stated otherwise, and the relative sizes of certain features may be exaggerated to better illustrate the features. Embodiments will be described with reference to the following figures, in which like numerals represent like items throughout the figures, and in which:

FIG. 1 shows a front view of an embodiment of the present invention, wherein the light guide is positioned to inject light into the bottom edge of a light guide plate.

FIG. 2 shows a front view of usage of the present invention, wherein an LCD panel with bezel covers the light guide plate.

FIG. 3 shows an edge illuminator with dual RGB LED chipsets and a rectangular light guide.

FIG. 4 shows a perspective view of a rectangular light guide having micro-structures on the top surface for edge lighting of the light guide plate.

FIG. 5 shows a rectangular light guide with tapered elements for edge lighting.

FIG. 6 shows a perspective view of a tapered light guide with micro structures on a top surface of the light guide.

### DETAILED DESCRIPTION

One or more embodiments of the present invention includes an elongated light guide apparatus adapted to accept light from two RGB LED chipsets, one on each end of the light guide, in order to produce highly uniform light that has a highly uniform color distribution and highly uniform intensity distribution. The highly uniform light is produced with high efficiency and at low cost by use of structures as described below.

One or more embodiments of the present invention includes a light guide plate adapted to accept light from the edge lighting apparatus, in order to produce backlight illumination for an LCD display.

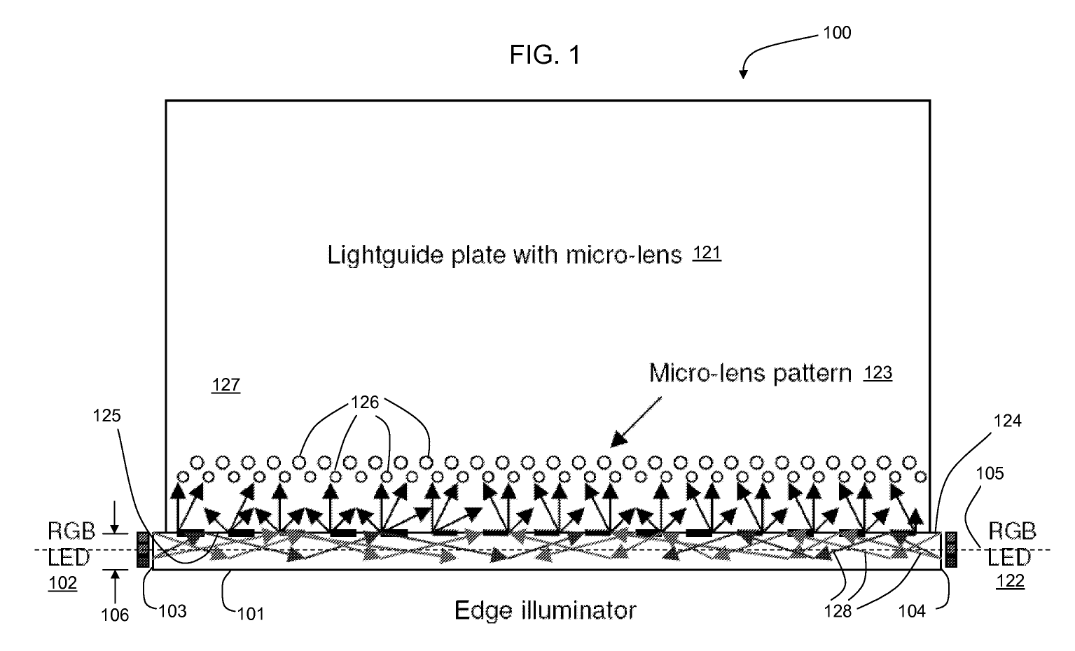

FIG. 1 shows an exemplary front view of an embodiment of the present invention, wherein the light guide is positioned to inject light into the bottom edge of a light guide plate.

FIG. 1 shows a front view of a first exemplary LED backlight unit 100, constructed from a light guide 101 and a light guide plate 121. Both light guide and light guide plate are relatively flat and thin, so that the overall LED backlight unit 100 can be very slim. As referred herein, the light guide 101 has: a first end 103 which received light from the set 102 of LEDs; a second end 104 which is opposite to the first end 103 and which received light from the set 122 of LEDs; an axis 105 which runs along the length of the light guide 101 from the first end 103 to the second end 104; a lateral edge surface 124 that abuts an edge 125 of light guide plate 121; a width 106 determined by a dimension of the light guide 101, transverse to the axis 105 and parallel to the plane of FIG. 1; and a thickness determined by a dimension of the light guide 101, transverse to the axis 105 and perpendicular to the plane of FIG. 1. Set 102 and set 122 of LEDs each includes at least one LED chip of each of red, green, and blue (“RGB”) color. A reflective surface (not shown) may be provided adjacent to the set 102 or set 122 of LEDs, in order to improve recycling of light toward light guide 101. Light guide 101 and light guide plate 121 are both made from a substantially transparent bulk plastic material such as PMMA. Each set 102 and 122 of RGB LEDs may have three or more surface-mounted RGB chips which can be driven at high current to provide sufficient light output with required white color when RGB light is well mixed.

Each set 102 and 122 of RGB LEDs is depicted here as one blue LED, one green LED, and one red LED, but persons of skill in the art will recognize that additional quantities of LEDs and/or varying ratios of the different colors of LEDs including white LEDs, may be used to achieve different desired brightness or color balance. The individual LEDs will ordinarily be arranged in an elongated pattern in one direction, such as one row or a small number of rows, in order to help maintain the overall flat and thin shape of light guide 101.

Light guide 101 accepts light from both set 102 and set 122 of RGB LEDs. After light enters the light guide 101, light rays 128 propagate through light guide 101. As light rays 128 first enter light guide 101, the color of light rays 128 will have a relatively strong dependency upon a linear position transverse to axis 105, because the color will be dominated by the color of the LED closest to that portion of the linear position. As light rays 128 continue propagating along light guide 101, colors will become mixed due to TIR reflections described below, thereby producing substantially white light. A color mixing region may be provided in the portions of light guide 101 that are adjacent to set 102 and set 122 of RGB LEDs, such that light will not be extracted from light guide 101 in the color mixing region. Because the transverse dimension of the light guide is small, the color mixing region is very short. If white LEDs are used, there is no need for the color mixing region.

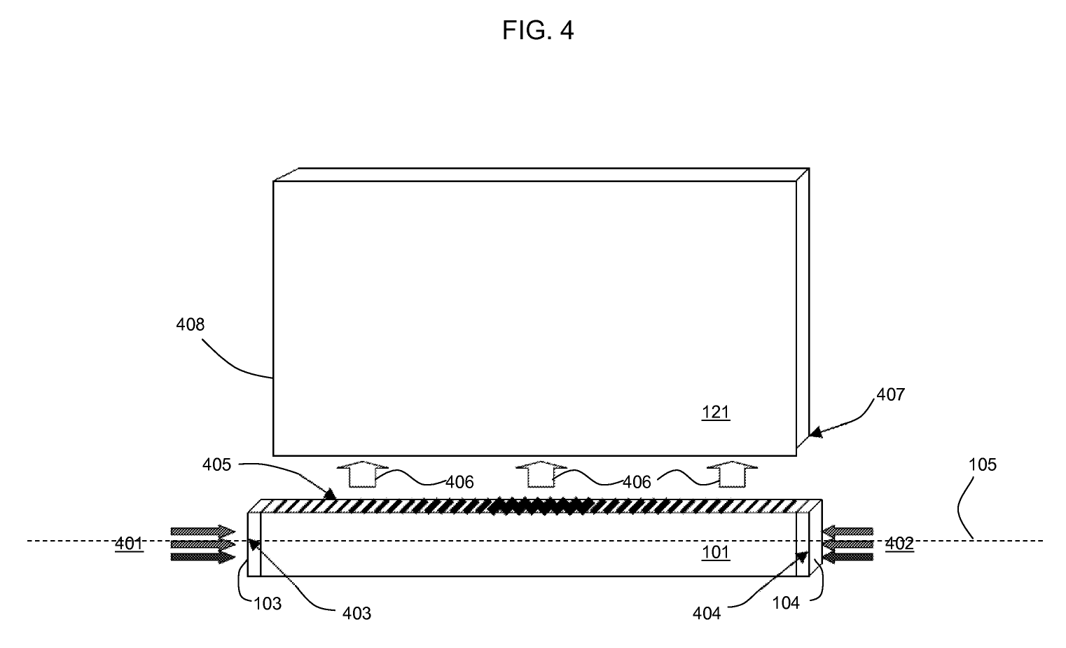

There exists a difference in the refractive index of the bulk material of light guide 101 and the medium that it is immersed in (usually air). The difference in refractive index creates a critical angle with respect to the perpendicular of a surface formed at a boundary between the bulk material and the medium. At angles less than the critical angle (i.e., close to perpendicular), light may be able to pass through the surface. At angles greater than the critical angle (i.e., shallow angles with respect to the surface, and away from the perpendicular), light will be totally reflected by the surface. This condition of total reflectance is called total internal reflection (TIR). Light rays 128 are contained within light guide 101 by use of TIR on the top, bottom, left and right interior surfaces of light guide 101, until the light is extracted by use of microstructures on one side of light guide 101, as described below in relation to FIG. 4. As light propagates through light guide 101, the color and intensity of the light will become more uniform.

The light guide plate 121 is optically coupled to the light guide 101 through the lateral edge surface 125 of light guide plate 121, which abuts the edge 124 of light guide 101. The light guide plate 121 has a first major surface 127 visible in FIG. 1, and a second major surface (not visible in FIG. 1) that is opposite from the first major surface. At least one of the first and second major surfaces has disposed thereon a plurality of micro-lens 126, forming a micro-lens pattern array 123. For sake of clarity, only a portion of the micro-lens pattern array 123 is illustrated in FIG. 1. FIG. 1 illustrates micro-lens 126 as having a circular shape, but the shape is not limited in this regard. Other shapes may be used, such as oval, rectangular, hexagonal, etc. Generally, substantially the entire surface area of the first major surface 127 or the second major surface is covered by the micro-lens pattern array 123. The function of micro-lens pattern array 123 is to extract light from light guide plate 121 in order to provide backlight illumination for an LCD panel overlying one major surface of the light guide plate 121. The sizes and placement of individual micro-lenses 126 across first major surface 127 or the second major surface will vary by design and/or as-measured manufacturing tolerances, based on a desired profile of light intensity to be extracted by the micro-lens pattern array 123.

In order to improve efficiency, one major surface, which is not immediately overlaid by the LCD panel, will have disposed thereon one or more recycling enhancement films, and the opposite major surface, which is immediately overlaid by the LCD panel, will have disposed thereon brightness enhancement films (“BEF”), and/or dual brightness enhancement films (“DBEF”) in order to improve the recycling of light toward the LCD panel. BEF is known as a microreplicated prism film that is used to increase display brightness by managing the exit angle of light. DBEF is known as a multi-layer reflective polarizing film which increases the amount of polarized light available for illuminating the LCD panel by recycling light that would normally be absorbed by a pre-polarizer in the LCD panel. The recycling enhancement film may also be formed from a reflective surface integrated together with a white diffuse reflector. Such recycling enhancement approach can increase the brightness on the LCD panel without additional increase of light output or power of LEDs. A light recycling film as used herein can be referred to a specular reflector or a mirror. The recycling enhancement component abuts the one major surface with no intended air gap.

The design of the micro-lens pattern array 123 takes into account both the calculated light intensity within light guide plate 121, and the brightness distribution that will be pleasing to a user and perceived by the user as being uniform across an overlying LCD panel. The perceived brightness of light emitted through the micro-lens pattern array 123 will be substantially balanced over light guide plate 121 by designing individual micro-lens 126 with a size and location that is matched to the intensity distribution within light guide plate 121 at the location of the individual micro-lens 126. The perceived uniformity of light distribution provided to illuminate a LCD display relates to optimal usage of available light. It is acceptable if the central region of a display is designed to be brighter than the periphery of the display (i.e., edges and corners) by about 10%-20%. From the center to the periphery, actual brightness gradually and symmetrically decreases, following a specified profile, so that the brightness variation across the LCD panel is not noticeable and visible by the viewers.

Design features of the micro-lens pattern array 123, of one or more embodiments of the present invention, may be varied to control the extraction of light from within the light guide plate 121. These design features include the size of a micro-lens 126; density of micro-lenses 126; and placement of micro-lenses 126 used to form the micro-lens pattern array 123. For equivalent light intensities within a light guide plate 121, a larger diameter micro-lens 126 will emit more light than a small diameter micro-lens 126, due to the difference in scattering or diffusing areas. Similarly, for equivalent light intensities within a light guide plate 121, a greater density of micro-lens 126 of a predetermined size will emit more light over an area than a smaller density of micro-lens 126 of the same predetermined size. Micro-lens patterns with increased micro-lens density and reduced micro-lens size play a very important role in the depth reduction of backlight units.

The features of micro-lens pattern array 123 may also vary as a function of position within the light guide plate 121. For instance, light intensity within the light guide plate 121 initially will be greater near the edges of light guide plate 121, because of reflections and light injection at surface 125, than the light intensity in the center of the light guide plate 121. Therefore, the sizes of micro-lenses are correspondingly adjusted to remove hot spots and to provide uniform perceived brightness distribution. As light propagates within the light guide plate 121, light mixing arising from internal reflections will cause the light intensity to become more uniform. Light extraction by micro-lens pattern array 123 through the light guide plate 121 also causes the light intensity propagating within the light guide plate 121 to change as a function of position.

To compensate for the variations of light intensity within the light guide plate 121, and to provide a perceived uniformity of brightness over a viewing area, the size of micro-lenses 126 may vary, with the larger micro-lenses 126 allowing more light to be released. The size of a micro-lens 126 at a predetermined location, the density of micro-lenses 126, and their placement within array 123 is designed by simulating the light intensity distribution within the light guide plate 121 at the predetermined location, and determining micro-lens 126 sizes that provide a desired brightness profile resulting in a perceived brightness uniformity.

Manufacturing tolerances and imperfections will affect the actual brightness distribution profile. Therefore, iterative processes may be used during manufacturing, such that an as-manufactured brightness profile can be measured, and the size of individual micro-lenses 126 are then adjusted (i.e., adapted) to provide a new-iteration as-manufactured brightness profile that is closer to the desired brightness profile. An exemplary process uses a diamond-turning machine, under the control of a CAD software program, to produce optimal micro-lens 126 patterns.

Micro-lens 126 may be a roughened area, such that the TIR condition is broken, thereby allowing light to be locally extracted out from the light guide. The degree of local roughness in a localized portion of the micro-lens 126 affects the angular distribution of light extracted from the localized portion of the micro-lens 126. The micro-lens 126 also may be a concavity formed in the surface of light guide plate 121 by a process such as milling, drilling, etching, laser ablation, etc., such that the TIR condition is broken. Micro-lens 126 may also be a convex protrusion from the surface of light guide plate 121 such that the TIR condition is broken. Embodiments of the invention are not limited by the method of making micro-lenses 126.

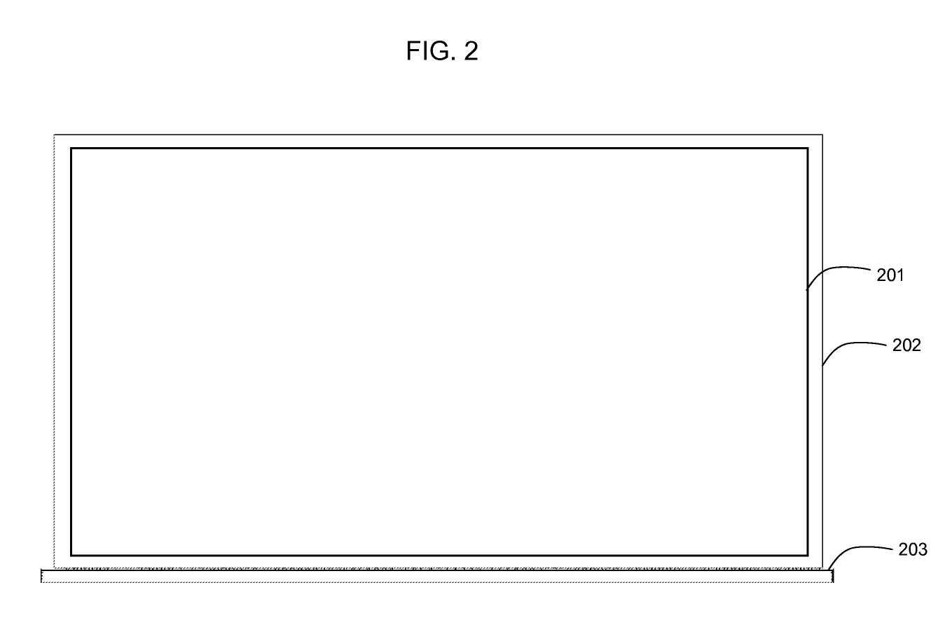

FIG. 2 illustrates an exemplary front view of usage of the present invention, wherein an LCD panel 201 with bezel 202 covers the light guide plate. Bezel 202 can be very small on three sides and functions to provide an aesthetically pleasing cover over a peripheral portion of light guide plate 121 that is not covered by the micro-lens pattern array 123. The LCD panel 201 is arranged substantially parallel to light guide plate 121. Light extracted by the micro-lens pattern array 123 passes through the LCD panel 201 to provide images. A bezel 203 or similar covering may also be provided over light guide 101.

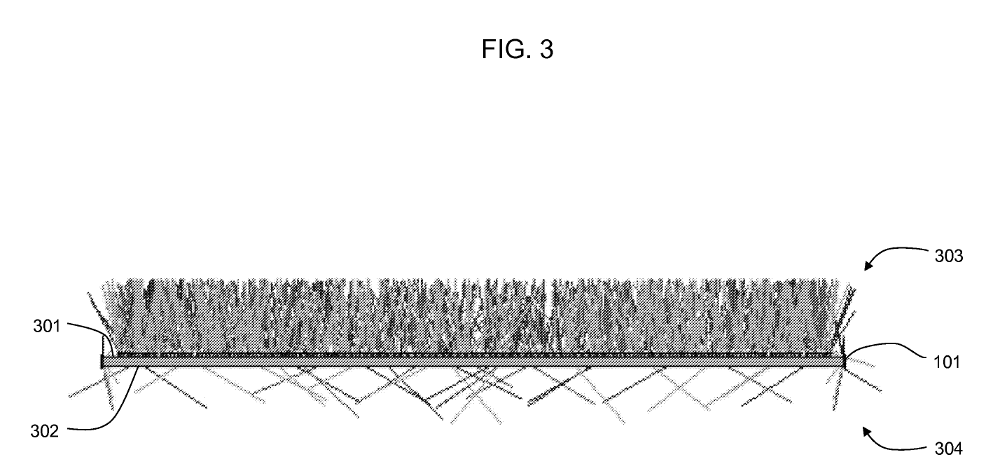

FIG. 3 illustrates exemplary light rays extracted from an edge illuminator with dual RGB LED chipsets and a rectangular light guide. Light guide 101 as illustrated in FIG. 3 has an upper surface 301, and a lower surface 302 that is opposite from upper surface 301. The upper surface 301 of the light guide 101 optically interfaces with the light guide plate 121 (not shown). Both the upper surface 301 and lower surface 302 are substantially perpendicular to the plane of FIG. 3. Light guide 101 also has a top surface (not marked), and a bottom surface (not marked) that is opposite from the top surface. Both the top surface and the bottom surface are substantially parallel to the plane of FIG. 3.

FIG. 3 further illustrates a plurality 303 of light rays extracted from upper side 301 and a plurality 304 of light rays escaping from the lower side 302. Upper surface 301 includes microstructures to extract light from light guide 101, as discussed below with respect to FIG. 4, therefore plurality 303 of light rays is dominantly large compared to plurality 304 of light rays.

Light rays escape from lower side 302 because the escaping rays do not meet the TIR condition at lower surface 302. In order to improve efficiency, a recycling enhancement component, such as a high-reflectivity reflector or a Mylar film, may be added to recycle light rays that escape through the lower surface 302. A back reflector may also be added adjacent to lower surface 302, in order to improve the light recycling efficiency. Such recycling enhancement approach can increase the brightness on the LCD panel without the increase of light output or power of LEDs. The recycling enhancement component abuts lower surface 302 with no intended air gap.

There is almost no leakage through the top and bottom surfaces of light guide 101 (i.e., the surfaces parallel to the plane of FIG. 3), because fewer light rays within light guide 101 are able to strike the top and bottom surfaces at an angle that does not meet the TIR condition, compared to upper surface 301 and lower surface 302. The recycling enhancement component and/or reflector may also be added to the top and bottom surfaces, but the improvement to efficiency will not be as great because not as many light rays escape from the top and bottom surfaces.

FIG. 4 is a perspective view that further illustrates the processing of light in the light guide 101 and light guide plate 121. Light rays 401 and 402 are generated by LEDs 102 and 122, respectively (not shown), and are directed toward light guide 101. Glass plates 403 and 404 with anti-reflective (“AR”) coatings can be attached to the ends of light guide 101 to improve the light coupling of the sets 102 and 122 of LEDs to light guide 101 with reduced reflection loss. Light is mixed within light guide 101 in order to produce substantially white light of a determinable intensity within the light guide 101. Disposed on the top surface of light guide 101 is an array of microstructure 405. Microstructure 405 functions as a plurality of light extractors to allow a portion of light to escape from the interior of the light guide 101. A microstructure as known in the art may be a roughened area, such that the TIR condition is broken, thereby allowing light to be locally extracted out from the light guide. The degree of local roughness in a localized portion of the microstructure 405 affects the angular distribution of light extracted from the localized portion of the microstructure 405. The microstructure 405 also may be a concavity formed in the surface of light guide 101 by a process such as milling, drilling, etching, laser ablation, etc., such that the TIR condition is broken. Microstructure 405 may also be a convex protrusion from the surface of light guide 101 such that the TIR condition is broken. Embodiments of the invention are not limited by the method of making microstructure 405.

The embodiment of FIG. 4 illustrates microstructure 405 as a plurality of roughened strips situated along the top side of light guide 101, each strip substantially transverse to axis 105. The roughened strips with proper width are spaced to uniformly extract light along the length of light guide 101. The width of each strip, for a predetermined position along light guide 101, is determined by the local light intensity within the light guide 101 and a desired light intensity to couple into light guide plate 121 at the predetermined position. Generally, the strips near the center of light guide 101 are wider than the strips near ends 103, 104 of light guide 101, the ends 103, 104 being closer to sets 401, 402 of LEDs. Wider strips extract more of the available light from light guide 101 than is extracted by narrower strips.

The light 406 extracted from microstructures 405 is substantially white in color, and is substantially uniform in intensity along the length of microstructures 405. Light 406 is coupled into light guide plate 121. For sake of clarity, FIG. 4 is drawn with an air gap between light guide 101 and light guide plate 121, but it should be known that in practice light guide 101 and light guide plate 121 will be assembled with a negligible air gap between them.

Light 406 enters light guide plate 121 through lower edge surface 407. The interface from light guide 101 to light guide plate 121 may be a light-spreading adaptation to spread light rays over a wider range of angles into light guide plate 121 in the direction parallel to the plane of FIG. 4, and thereby achieve more uniform intensity and color of light within light guide plate 121. In one embodiment, the light-spreading adaptation may include lenticular structures on lower edge surface 407. Lenticular structures are known in the art as an array of micro-ridges. Micro-lens pattern array 123 (not shown in FIG. 4) is positioned on the front major surface 408 of light guide plate 121. Micro-lens pattern 123 and microstructure 405 together are designed to provide a desired distribution of extracted light from the light guide plate 121.

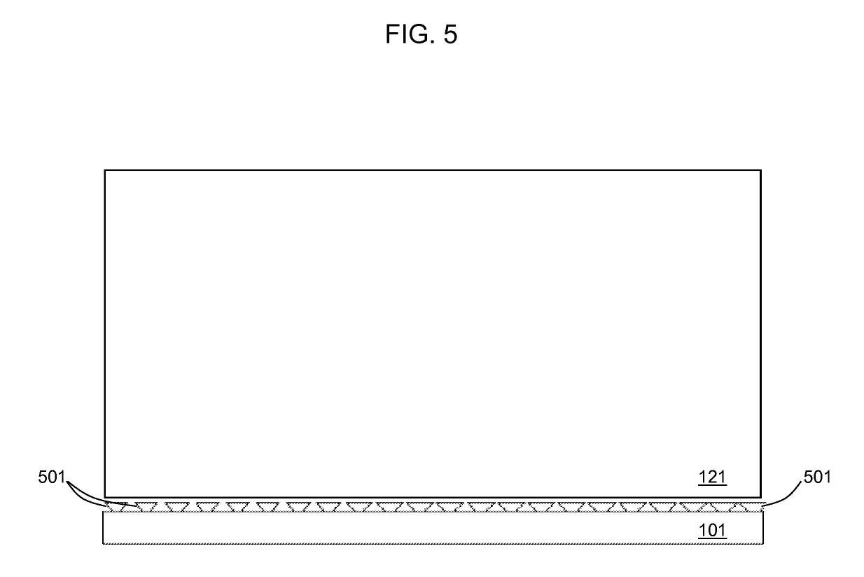

FIG. 5 illustrates another embodiment of the plurality of light extractors, wherein a plurality of tapered elements 501 direct light from the top surface of light guide 101, into light guide plate 121. The tapered elements 501 have tapered surfaces in the plane of FIG. 5, with a narrow end adjacent to light guide 101, and a wider end adjacent to light guide plate 121. The thickness of the tapered elements 501 is substantially the same as that of the light guide 101. Tapered elements 501 can be injection-molded together with the light guide 101. Light to be extracted enters from the bottom of tapered elements 501, and the amount of extracted light depends on the bottom opening of the corresponding tapered element. Light propagating through tapered elements 501 is TIR-reflected by the tapered surfaces towards the light guide plate 121. The half cone-angle of tapered elements is in the range between approximately 35° to 42°. Micro-structures may be introduced on the tapered element 501 at the junction with the light guide plate 121 in order to improve the uniformity of light injected into light guide plate 121.

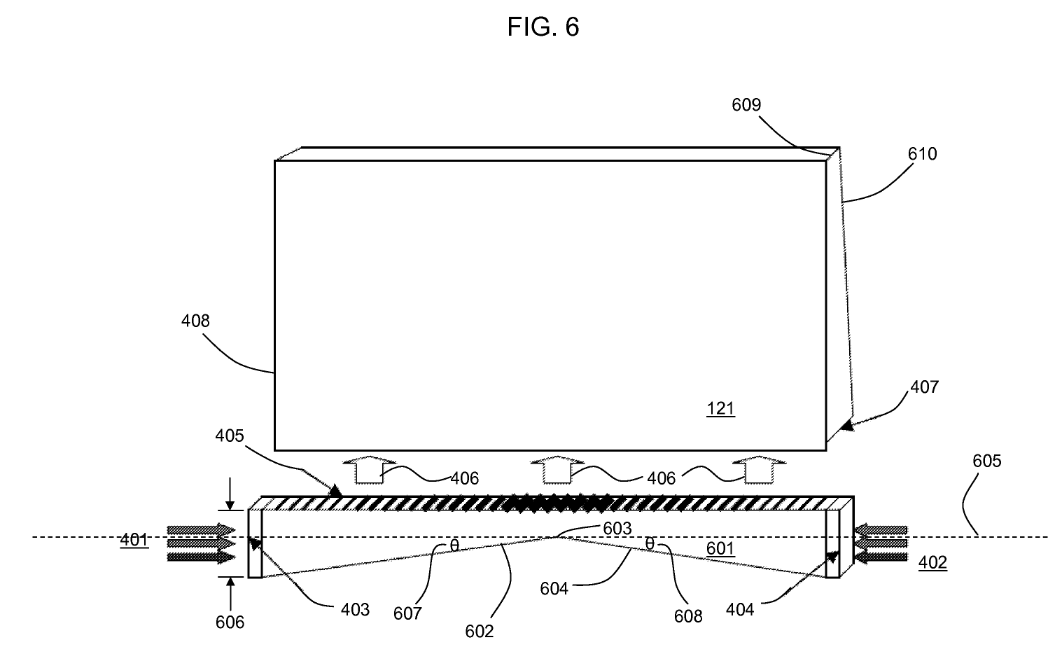

In another aspect of the invention, FIG. 6 illustrates light guide 601 having a lower surface formed from two or more sections 602, 604. The two or more sections 602, 604 include at least one section that is situated at a non-parallel angle with respect to axis 605. The two or more sections 602, 604 together form a lower surface in which width 606 varies along the length of light guide 601. As illustrated in the embodiment of FIG. 6, sections 602 and 604 are both angled with respect to axis 605 and join to form one or more protrusions 603 into the interior of light guide 601. The protrusion 603 may extend into light guide 601 by about half of the width 606 at the end of light guide 601, but the invention is not limited in this respect and protrusion 603 may extend more than or less than half of the width 606 at the end of light guide 601. Although FIG. 6 is illustrated with angles 607 and 608 being substantially equal, embodiments of the invention are not limited in this respect. Angles 607 and 608 may be unequal if the sections 602, 604 are of unequal lengths. In other embodiments (not illustrated), lower surface of light guide 601 may comprise a concave curve or a toroidal shape.

Section 602 functions to direct a portion of light from set 401 of LEDs toward the upper surface of light guide 601, and section 604 functions to direct a portion of light from set 403 of LEDs toward the upper surface of light guide 601. By directing the light from sets 401 and 403 in this way, the efficiency of light extraction by microstructure 405 is improved. The angles 607 and 608 with respect to axis 605 are not so great as to cause a loss of TIR condition at sections 602 and 604 for most light rays propagating through light guide 601.

In a further embodiment, a thickness 609 of the upper edge surface can be less than the thickness of lower edge surface 407, thereby providing a wedge shape to light guide plate 121 in a vertical direction. Preferably, the wedge shape is oriented such that front major surface 408 is substantially vertical, and a rear major surface 610 is slanted away from vertical. Providing a wedge shape for the light guide plate 121 has a first advantage of reducing the bulk of light guide plate 121 and the associated cost and weight. A second advantage is that as light propagating from the lower edge surface 407 is reflected from the rear major surface 610, the reflected light will be directed toward the front major surface 408. The wedge shape is not so great as to cause a loss of TIR condition at the rear major surface 610 for most light rays propagating through light guide plate 121. The thickness of lower edge surface 407 is constrained by the thickness of light guide 101, such that the best coupling of light from light guide 101 into light guide plate 121 is attained when the thickness of lower edge surface 407 is approximately the same as the thickness of the light guide 101.

Simulations have been carried out to calculate the intensity distribution of the red, green, and blue components of light produced to illuminate an LCD panel. The simulations provide design parameters for uniform white light intensity distribution over the entire viewing surface of an LCD panel.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments of the present invention have been described herein for proper color mixing to generate white light. However, it will be understood by persons of ordinary skill in the art that the individual red, green, and blue LEDs may be turned on and off sequentially in order to display a color image. A color image is perceived by a user when the individual red, green, and blue LEDs are switched on and off in synchronism with the LCD panel displaying an image tailored for the color(s) that are switched on. This is a special and useful feature if the LCD panel can be switched very fast.

We claim:

1. An edge-illuminated LED backlight apparatus to provide uniform light distribution for LCD backlighting, comprising:
an elongated light-transmissive bulk material having a first end, a second end, a central axis running from the first end to the second end, a first edge surface connecting the first end and the second end, and a second edge surface opposing said first edge surface;
first and second input windows on the first and second ends, respectively, the first and second input windows configured to allow light from a plurality of light sources to enter the elongated light-transmissive bulk material;
a plurality of light extractors disposed on the first edge surface of the elongated light-transmissive bulk material, each said light extractor configured to allow a fraction of light to escape from the interior of the elongated light-transmissive bulk material;
a flat light-transmissive bulk material having a first major surface, a second major surface, and a lower edge surface transverse to the first major surface and the second major surface, wherein the lower edge surface of the flat light-transmissive bulk material is optically coupled to the plurality of light extractors of the elongated light-transmissive bulk material; and
a plurality of micro-lenses disposed on one or more of the major surfaces of the flat light-transmissive bulk material.

2. The apparatus according to claim 1, wherein the plurality of light extractors comprises a plurality of micro-structured strips oriented transverse to the central axis of the elongated light-transmissive bulk material.

3. The apparatus according to claim 1, wherein the plurality of light extractors comprises a plurality of tapered elements.

4. The light-transmissive light guide according to claim 2, wherein dimensions of the micro-structured strips are adapted to compensate for uneven light intensity within the elongated light-transmissive bulk material to produce a desired light intensity pattern along a length of said first edge surface.

5. The light-transmissive light guide according to claim 3, wherein dimensions of the tapered elements are adapted to compensate for uneven light intensity within the elongated light-transmissive bulk material to produce a desired light intensity pattern along a length of said first edge surface.

6. The light-transmissive light guide according to claim 1, wherein at least one end of the elongated light-transmissive bulk material comprise a surface having an anti-reflective coating.

7. The apparatus according to claim 1, further comprising a reflective film disposed on the second edge surface of the elongated light-transmissive bulk material.

8. The apparatus according to claim 1, further comprising a recycling enhancement film disposed on the second major surface of the flat light-transmissive bulk material.

9. The apparatus according to claim 1, wherein the lower edge surface of the flat light-transmissive bulk material comprises an anti-reflective coating.

10. The apparatus according to claim 1, wherein the lower edge surface of the flat light-transmissive bulk material comprises lenticular structures.

11. The apparatus according to claim 1, wherein the second edge surface of the elongated light-transmissive bulk material comprises a non-planar surface wherein the width varies along the length of the elongated bulk material.

12. The apparatus according to claim 1, wherein the second edge surface of the elongated light-transmissive bulk material comprises a plurality of planar sections having different orientations.

13. The apparatus according to claim 1, wherein the second edge surface of the elongated light-transmissive bulk material comprises a concavely-curved surface.

14. The light-transmissive light guide according to claim 1, wherein the plurality of micro-lenses are adapted to compensate for uneven light intensity within the flat light-transmissive bulk material, to produce a desired light intensity pattern across one or more of the major surfaces of the flat light-transmissive bulk material.

15. An edge-illuminated LED backlight apparatus to provide uniform light distribution for LCD backlighting, comprising:
an elongated light-transmissive bulk material having a first end, a second end, a central axis running from the first end to the second end, a first edge surface connecting the first end and the second end, and a second edge surface opposing said first edge surface, wherein a total internal reflective condition exists on an interior-facing side of at least one edge surface of the elongated light-transmissive bulk material;
first and second input windows on the first and second ends, respectively, the first and second input windows configured to allow light from one or more LEDs selected from the group consisting of white LEDs, red LEDs, green LEDs, and blue LEDs to enter the elongated light-transmissive bulk material;
a plurality of light extractors disposed on the first edge surface of the elongated light-transmissive bulk material;
a flat light-transmissive bulk material having a first major surface, a second major surface, and a lower edge surface transverse to the first major surface and the second major surface, wherein the lower edge surface of the flat light-transmissive bulk material is optically coupled to the plurality of light extractors of the elongated light-transmissive bulk material, wherein a total internal reflective condition exists on an interior-facing side of at least one surface of the flat light-transmissive bulk material; and
a plurality of micro-lenses disposed on one or more of the major surfaces of the flat light-transmissive bulk material, the micro-lenses comprising optically-shaped portions on the one or more major surfaces, wherein the optically-shaped portion is configured to allow a fraction of light to escape from the interior of the flat light-transmissive bulk material by a loss of the total internal reflective condition at the optically-shaped portion.

16. The apparatus according to claim 15, wherein the flat light-transmissive bulk material further comprises an upper edge surface opposing said lower edge surface, the upper edge surface having a thickness that is less than the thickness of the lower edge surface, such that the flat light-transmissive bulk material is wedged in one direction.

17. A method for coupling and re-distributing light in a backlight unit, comprising:
communicating light from a plurality of lights sources, through at least one input window, into an elongated light-transmissive bulk material;
emitting said light from the elongated bulk material, through a plurality of light extractors disposed on a first edge of the elongated bulk material, into a flat light-transmissive bulk material; and
emitting said light from the flat light-transmissive bulk material through a plurality of micro-lenses disposed on major surfaces of the flat light-transmissive bulk material.

18. The method according to claim 17, further comprising the step of recycling light that exits the elongated light-transmissive bulk material from a second edge back towards the first edge, by use of a reflective film.

19. The method according to claim 17, prior to said emitting step, selectively positioning micro-lenses on the major surfaces of the flat light-transmissive bulk material.
